(19) United States
(12) Patent Application Publication
(10) Pub. No.: US 2017/0256969 A1
(43) Pub. Date: Sep. 7, 2017

(54) Quick Charging Data Line of USB Interface

(71) Applicant: Yan Gan Du, Changsha City (CN)

(72) Inventor: Yan Gan Du, Changsha City (CN)

(21) Appl. No.: 15/059,336

(22) Filed: Mar. 3, 2016

(51) Int. Cl. H02J 7/00; G06F 1/26; G06F 13/40; G06F 13/38; G06F 13/42; G06F 13/364

(52) U.S. Cl. CPC H02J 7/0052; G06F 13/4282; G06F 13/364; G06F 13/4022; G06F 13/385; G06F 1/263; H02J 7/0047; H02J 2007/0059; H02J 2007/0062

(57) ABSTRACT

The present invention discloses a quick charging data line of a USB interface, comprising: a boosting module arranged between a host end of a USB data line connected with a primary device and a slave end connected with an assistant device; and a mode switching module that realizes power supply through the boosting module, wherein after boosting the voltage of the power supply end of the host end of the USB data line from 5V to 5.1-5.4V, the boosting module is connected with the slave end; the mode switching module at least comprises a control module for controlling the magnitude of output current, wherein the control module can control the magnitude of charging current inputted into the slave end through a port of the control module; and the mode switching module also comprises an LED output portion which can realize button input of mode selection and can prompt the current operating mode of the data line for a user. The present invention controls the magnitude of the output current through the boosting module and the mode switching module, thereby greatly enhancing the charge of a computer for the device, so that the current transmitted by an ordinary data line is increased from the original maximum 500 mA to about 1.8 A, and therefore, the purpose of USB quick charging is achieved.

### TECHNICAL FIELD

The present invention relates to the technical field of data lines, and more particularly, relates to a quick charging data line of a USB interface.

### BACKGROUND

The current widely-used charging mode is to charge the existing mobile terminal or other electronic devices through a USB data line. The data line only performs the function of connecting a USB port and a device to be charged. The charging speed depends on the output voltage and current of the USB port. The voltage of a standard USB port of a computer is designed to be 5V, and the output current is only about 500 mA. Therefore, using the standard USB port of the computer for charging the device to be charged generates the problem of low speed and the problem of being easy to shorten and damage data by data transmission.

Thus, the problem to be solved by those skilled in the art is how to provide a charging data line or device to enable the USB interface of an ordinary computer to realize quick charging.

### SUMMARY

In view of this, the present invention provides a quick charging data line of a USB interface, thereby not only solving the problem of low charging speed of the standard USB port of the existing computer, but also controlling the magnitude of the output current through the boosting module and the mode switching module and having stronger controllability.

To achieve the above purpose, the present invention provides the following technical solution:

A quick charging data line of a USB interface comprises: a boosting module arranged between a host end of a USB data line connected with a primary device and a slave end connected with an assistant device; and a mode switching module that realizes power supply through the boosting module, wherein after boosting the voltage of the power supply end of the host end of the USB data line from 5V to 5.1-5.4V, the boosting module is connected with the slave end; the mode switching module at least comprises a control module for controlling the magnitude of output current, wherein the control module can control the magnitude of charging current inputted into the slave end through a port of the control module; and the mode switching module also comprises an LED output portion which can realize button input of mode selection and can prompt the current operating mode of the data line for a user.

Preferably, in the above-mentioned quick charging data line of the USB interface, the mode switching module at least has two modes: a standard USB mode and a quick charging mode, wherein the standard USB mode is controlled by a standard USB protocol; the quick charging mode is disconnected from a data protocol of the host, and the mode switching module and the boosting module completely autonomously control the charging current simultaneously.

Preferably, in the above-mentioned quick charging data line of the USB interface, the USB male of the data line can be replaced by a USB female as an adapting device.

It is known from the above technical solution that compared with the prior art, the present invention discloses and provides a quick charging data line of a USB interface; by adding a boosting module between the host end and the slave end, the purpose of quick charging is achieved and more time is saved. Meanwhile, the boosting module can control the magnitude of the output current, thereby achieving the purpose of quick charging on the USB interface of an ordinary computer.

### DESCRIPTION OF THE DRAWINGS

To more clearly describe the technical solutions in the embodiments of the present invention or in prior art, the drawings required to be used in the description of the embodiments or the prior art will be simply presented below. Apparently, the drawings in the following description are merely the embodiments of the present invention, and for those skilled in the art, other drawings can also be obtained according to the provided drawings without contributing creative labor.

FIG. 1 is a structural principle diagram of the present invention.

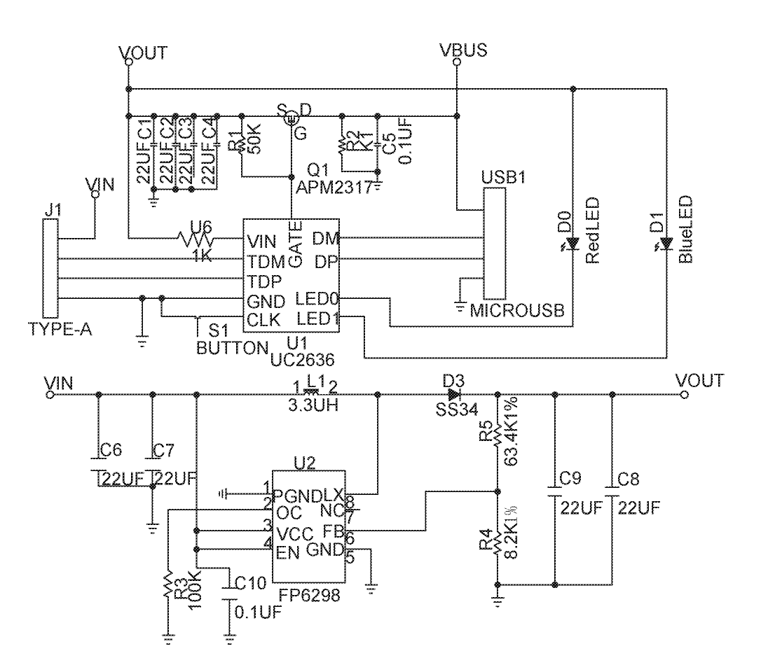

### DETAILED DESCRIPTION

The technical solutions in the embodiments of the present invention will be clearly and fully described below with combination of the drawings in the embodiments of the present invention. Apparently, the described embodiments are merely part of the embodiments of the present invention, not all of the embodiments. Based on the embodiments in the present invention, all other embodiments obtained by those skilled in the art without contributing creative labor will belong to the protection scope of the present invention.

With reference to the related drawings, the embodiment of the present invention discloses a quick charging data line of a USB interface, comprising: a boosting module arranged between a host end of a USB data line connected with a primary device and a slave end connected with an assistant device; and a mode switching module that realizes power supply through the boosting module, wherein after boosting the voltage of the power supply end of the host end of the USB data line from 5V to 5.1-5.4V, the boosting module is connected with the slave end; the mode switching module at least comprises a control module for controlling the magnitude of output current, wherein the control module can control the magnitude of charging current inputted into the slave end through a port of the control module; and the mode switching module also comprises an LED output portion which can realize button input of mode selection and can prompt the current operating mode of the data line for a user.

To further optimize the above technical solution, the mode switching module at least has two modes: a standard USB mode and a quick charging mode, wherein the standard USB mode is controlled by a standard USB protocol; the quick charging mode is disconnected from a data protocol of the host, and the mode switching module and the boosting module completely autonomously control the charging current simultaneously.

To further optimize the above technical solution, the USB male of the data line can be replaced by a USB female as an adapting device.

The whole principle diagram of the present invention comprises two portions: a boosting module and a mode switching module.

A circuit main body of the boosting module portion comprises a voltage boosting chip FP6298. The power output end VIN of the host end of the USB data line is connected with the power supply end of FP6298. Moreover, after an inductor L1 is used for boosting and a diode is connected, boosted voltage VOUT is outputted; and the outputted voltage VOUT can be regulated by regulating the structures of resistors R4 and R5.

The power supply of the mode switching module is realized by the voltage VOUT outputted by the boosting module portion. The circuit main body of the module comprises a charging adapter managing chip UC2636 with a module switch. The data input end of UC2636 is connected with the data line of the host end. The data output end of UC2636 is connected with the data line of the slave end. The control end is connected with G end of an MOS transistor Q1. S end of Q1 is connected with VOUT. D end of Q1 is connected with VBUS of the power supply end of the slave end. CLK of UC2636 is connected with a button S1. UC2636 controls and switches two operating modes by identifying the input of the button S1. The first mode is a standard USB mode, which can realize data transmission and charging at 400 mA. The second mode is a quick charging mode. After entering the mode, UC2636 is disconnected from the data protocol of the computer. The charging state is not controlled by the USB protocol of the computer end, but UC2636 intelligently identifies the device to be charged for achieving quick charging. A maximum of 1.8A of quick charging can be achieved. Light-emitting diodes can be externally connected to pins of LED 0 and LED 1 of UC2636 for indicating the current operating mode and state.

Each embodiment in the description is described in a progressive way. The difference of each embodiment from each other is the focus of explanation. The same and similar parts among all of the embodiments can be referred to each other. For the device disclosed by the embodiment, because the device corresponds to the method disclosed by the embodiment, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A quick charging data line of a USB interface, which is characterized by comprising: a boosting module arranged between a host end of a USB data line connected with a primary device and a slave end connected with an assistant device; and a mode switching module that realizes power supply through said boosting module, wherein after boosting the voltage of the power supply end of the host end of the USB data line from 5V to 5.1-5.4V, said boosting module is connected with the slave end; said mode switching module at least comprises a control module for controlling the magnitude of output current, wherein the control module can control the magnitude of charging current inputted into the slave end through a port of the control module; and said mode switching module also comprises an LED output portion which can realize button input of mode selection and can prompt the current operating mode of the data line for a user.

2. The quick charging data line of the USB interface according to claim 1, characterized in that said mode switching module at least has two modes: a standard USB mode and a quick charging mode, wherein the standard USB mode is controlled by a standard USB protocol; the quick charging mode is disconnected from a data protocol of the host, and the mode switching module and the boosting module completely autonomously control the charging current simultaneously.

3. The quick charging data line of the USB interface according to claim 1, characterized in that the USB male of said data line can be replaced by a USB female as an adapting device.
